(19) United States
(12) Patent Application Publication
(10) Pub. No.: US 2026/0153367 A1
(43) Pub. Date: Jun. 4, 2026

(54) Alignment and Stabilization Bracket for Tripod-Mounted Electronic Measurement Devices

(71) Applicant: David Wetherington, Golden, CO (US)

(72) Inventor: David Wetherington, Golden, CO (US)

(21) Appl. No.: 19/458,711

(22) Filed: Jan. 24, 2026

(51) Int. Cl. G01D 11/30

(52) U.S. Cl. CPC G01D 11/30

(57) ABSTRACT

A mechanical alignment and stabilization accessory for tripod-mounted electronic devices is disclosed. The accessory engages an OEM mounting base of the device and structural features of the tripod to reduce rotational looseness and positional inconsistencies caused by manufacturing tolerances. In one embodiment, a bracket clips around a central tripod pillar and slides into engagement with support fins or beams, providing vertical bracing that indexes the device into a fixed rotational alignment relative to tripod legs. In another embodiment, internal bracing walls of the bracket engage the device as it is rotated into its normal mounting position, preventing further rotation and stabilizing alignment. The accessory ensures consistent positioning of the device relative to OEM or aftermarket accessories, such as alignment stands, laser guides, or calibration tools. By improving alignment repeatability and rigidity, the invention enhances measurement accuracy, simplifies setup, and accommodates future accessory integration without modification to the tripod or device.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention relates generally to mounting accessories for tripod-supported electronic devices. More particularly, the invention relates to mechanical alignment and stabilization accessories for launch monitors and similar precision electronic measurement devices mounted to tripods. The invention addresses rotational looseness and tolerance variability between an original equipment manufacturer (OEM) mounting interface and a tripod. The invention improves repeatable alignment between the device, the tripod legs, and associated alignment or calibration accessories.

### Description of the Related Art

The present invention falls within the general field of mechanical mounting accessories for tripod-supported electronic devices. More specifically, the invention relates to alignment, stabilization, and positional control systems used in conjunction with electronic measurement, sensing, imaging, and data-capture devices that are mounted to tripods or similar support structures. Such devices include, but are not limited to, sports performance measurement systems, optical sensors, cameras, scanners, surveying instruments, and calibration equipment. The invention addresses mechanical and geometric challenges associated with rotational instability, tolerance variation, and inconsistent alignment between an electronic device and its supporting tripod.

Tripods are widely used because they provide a portable, adjustable, and stable platform for supporting electronic devices. However, most tripods are designed as general-purpose supports rather than precision alignment systems. As a result, the interfaces between tripods and electronic devices are often optimized for ease of attachment and manufacturability rather than for precise angular indexing. The present invention operates within this field by introducing a supplemental mechanical alignment system that works in conjunction with existing tripod and device designs.

Accurate alignment is a critical requirement for many tripod-mounted electronic devices, particularly those that rely on directional measurement, optical sensing, or spatial reference frames. In applications such as sports analytics, surveying, motion capture, and imaging, even small angular deviations can lead to significant measurement errors, inconsistent data, or degraded performance. As electronic devices become more sophisticated and precise, the importance of repeatable and reliable alignment increases correspondingly.

In many real-world use cases, alignment must be established quickly and repeatedly by users with varying levels of technical expertise. Professional users may require consistent alignment across multiple sessions, locations, or devices, while consumer users often seek simplicity and ease of setup. In both cases, reliance on manual alignment processes or visual estimation introduces variability and increases the likelihood of error. Therefore, mechanical solutions that enforce alignment inherently, rather than relying on user judgment, are of substantial importance to the usability and reliability of tripod-mounted systems.

The use of tripod-mounted electronic devices has expanded rapidly due to the growth of portable electronics, data analytics, and consumer-level measurement tools. In sports technology alone, millions of tripod-mounted devices are sold annually worldwide, ranging from professional training systems to consumer-grade performance trackers. These devices are increasingly used in environments where repeatability and precision are expected, such as indoor training facilities, outdoor ranges, and mobile setups. Despite this growth, the fundamental tripod mounting interface has changed little over decades. Most systems rely on standardized threaded mounts or rotational locking mechanisms that prioritize compatibility over precision. Manufacturing tolerances in these interfaces can result in rotational play on the order of several degrees, which is sufficient to cause noticeable misalignment in precision applications. Users frequently report the need to manually realign devices after installation, bumping, or removal, indicating a persistent and widespread problem.

Market feedback and user behavior demonstrate that many users resort to improvised solutions, such as shimming, marking alignment positions, or using external reference tools, to compensate for these deficiencies. The prevalence of such workarounds highlights both the importance of the problem and the lack of a standardized, mechanical solution within the existing ecosystem.

Prior art in the field of tripod mounting and stabilization primarily focuses on improving rigidity, vibration damping, and load capacity rather than precise rotational alignment. Common innovations include quick-release plates, ball heads, leveling bases, and friction-based locking mechanisms. While these solutions improve convenience and stability, they do not inherently enforce a fixed rotational orientation between the electronic device and the tripod legs.

Some systems incorporate visual alignment aids, such as printed markings, spirit levels, or laser guides, to assist users in manually aligning devices. While these aids can improve accuracy when used correctly, they remain dependent on user attention and skill. Additionally, they do not prevent the device from rotating slightly due to looseness in the mounting interface once alignment has been established.

In specialized professional equipment, custom mounting fixtures or keyed interfaces are sometimes used to ensure precise alignment. However, these solutions are typically integrated into proprietary systems and are not compatible with consumer tripods or OEM mounting standards. As a result, such innovations are limited in scope and do not address the broader market of existing devices and tripods.

While existing solutions provide certain advantages, significant shortcomings remain. The primary advantage of current tripod mounting systems is their universality and ease of use. Users can quickly attach and detach devices without specialized tools, and standardized interfaces ensure broad compatibility. However, this convenience comes at the cost of precision and repeatability.

One major shortcoming is rotational looseness at the OEM mounting interface. Even when tightened fully, many devices can rotate slightly due to clearance between mating components. This rotation may occur during installation, transportation, or normal use. Users must then re-establish alignment manually, often without a reliable reference.

Another shortcoming is the lack of a mechanical reference between the electronic device and the tripod legs. Tripod legs define the physical footprint and orientation of the system, yet most mounting interfaces are rotationally independent of leg position. This disconnect makes it difficult to align devices with accessories that assume a known relationship to the tripod geometry.

Additionally, users face inconsistency across different setups. The same device may align differently each time it is mounted, leading to variability in results and reduced confidence in measurements. These issues persist across both consumer and professional segments, indicating a fundamental gap in current tripod mounting solutions.

By looking at prior art, various innovations can be seen. For instance, an EP patent 1,160,499A1 relates to Camera-to-tripod quick-release mounting. The patent describes an improved quick-release coupling between a camera (or other optical device) and a tripod, including a base and a releasable shoe. A locking mechanism using spring-biased components secures and releases the shoe from the base. The system also provides discrete rotational indexing positions so the shoe can be attached in multiple fixed orientations. An anti-twist arrangement is included in which an anti-twist plate is keyed relative to the camera and cooperates with a pin register plate and retractable pin so the shoe is prevented from twisting relative to the camera when tightened.

A U.S. Pat. No. 8,261,954B2 relates to Mount with anti-rotation feature. The patent discloses a mount (described for motorcycles and other vehicles) that resists relative rotational movement at the connection between the mount and the vehicle, and also at the connection between the mount and a plate that supports a portable device (e.g., GPS, toll transponder, radar detector). The mount uses anti-rotation features to prevent unwanted rotation during normal use, while allowing disengagement at one or more connections when subjected to a sufficiently large force (e.g., severe impact), improving safety and retention behavior.

A U.S. Pat. No. 8,613,379B2 relates to scooter device mounting assembly. The patent describes a device mounting assembly intended for attachment to a scooter (e.g., mirror mount) so a portable device such as a phone can be positioned for rider access. The system includes severable pin connections at the vehicle side and/or device side. These pin connections help resist relative movement (including rotation) during normal operation, but are configured to sever when sufficient force is applied, thereby reducing the risk of the mounted device disengaging violently from the vehicle during an accident or high-force event.

A U.S. Pat. No. 9,791,096B2 relates to anti-rotation bracket. The patent discloses an anti-rotation bracket and related assemblies in which a mounting component includes a through-hole for a fastener and structural features including a flange and spaced tabs. In an assembly, a boss extends from a base plate and a fastener passes through the mounting component into the boss. An anti-rotation projection fixed to the boss is positioned between the tabs to resist rotation. The patent also describes methods of forming such assemblies by positioning the mounting component so the anti-rotation feature is captured between the tabs and then fastening with the fastener.

A US patent 2,015,0301560A1 relates to case and a mounting apparatus for a tablet computer. The patent describes a protective tablet case with integrated mounting features, including molded threaded inserts and a receptacle for a cam-lock interface. Multiple removable mounting assemblies can attach to the case, including a handle assembly and a tripod mount assembly. A cam-lock assembly can also couple to the case in different orientations (e.g., at 90-degree intervals) and can accept additional mounts such as headrest and seat-tray mounts. The goal is to provide a modular system to protect the tablet and allow mounting/positioning on tripods and other supports for hands-free use.

The present invention introduces a mechanical alignment and stabilization system designed specifically to address the shortcomings of existing tripod mounting interfaces. Rather than replacing the OEM mounting mechanism, the invention operates as a supplemental accessory that works in conjunction with existing devices and tripods. This approach preserves compatibility while introducing a new level of alignment control.

The system comprises a bracket or similar structure that engages both the electronic device and fixed structural features of the tripod. By referencing the tripod's geometry, such as support fins or leg connection structures, the system establishes a mechanical relationship between the device and the tripod legs. This relationship defines a predetermined rotational orientation that is independent of OEM mounting tolerances.

In one implementation, the system uses a slide-up bracing mechanism that engages tripod support structures to provide vertical and rotational constraint. In another implementation, the system uses rotational stop surfaces that engage the device during installation to prevent over-rotation. Both implementations are designed to be simple, robust, and easy to use.

The present system fulfills a clear and unmet market need by providing a mechanical solution to a problem that has traditionally been addressed through manual adjustment or improvised methods. By enforcing alignment mechanically, the system removes variability introduced by user behavior, manufacturing tolerances, and wear over time. This results in a more reliable and user-friendly experience.

From a market perspective, the system is particularly valuable because it is compatible with existing equipment. Users do not need to replace their devices or tripods to benefit from improved alignment. This retrofit capability lowers the barrier to adoption and expands the potential user base across consumer, semi-professional, and professional segments.

The system also enables consistent use of alignment-dependent accessories, both current and future. As the ecosystem of accessories continues to grow, a stable and predictable alignment reference becomes increasingly important. By aligning the device with the tripod legs, the system provides a universal reference that accessory designers can rely on.

Ultimately, the present invention bridges the gap between convenience and precision. It retains the simplicity of existing tripod mounting systems while introducing a level of alignment control previously unavailable in this market. In doing so, it enhances measurement accuracy, reduces setup time, and improves user confidence, thereby fulfilling a longstanding and widely recognized need in the field.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The invention's objective is to provide a mechanical accessory that stabilizes a tripod-mounted electronic device by reducing rotational looseness at an OEM mounting interface.

A further objective of the present invention is to ensure consistent and repeatable alignment between an electronic device and tripod legs, regardless of manufacturing tolerances in the OEM connection.

It is also an object of the invention to mechanically reference fixed structural features of a tripod to define a predetermined rotational orientation of the electronic device.

It is further the objective of the invention to improve compatibility between tripod-mounted electronic devices and alignment-dependent accessories, including OEM and aftermarket alignment, leveling, and calibration tools.

It is also the objective of the invention to eliminate the need for repeated manual alignment adjustments when installing or reinstalling a tripod-mounted electronic device.

The objective of the invention is to provide an alignment solution that does not require permanent modification of the electronic device or the tripod.

It is also the objective of the invention to compensate for tolerance variability, wear, and looseness inherent in threaded or rotational OEM tripod mounting mechanisms.

It is further the objective of the invention to allow consistent alignment across multiple setup and teardown cycles of the electronic device.

The invention aims to enable accurate and reliable use of laser alignment tools, targeting aids, and calibration stands by enforcing a fixed device orientation.

It is the objective of the system to provide a removable, reusable, and user-friendly alignment accessory suitable for both consumer and professional environments.

The invention also aims to support current and future electronic devices and accessories by providing a scalable and adaptable alignment interface.

It is the objective of the invention to improve overall measurement accuracy, user confidence, and setup efficiency for tripod-mounted electronic measurement systems.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The drawings described herein are provided for purposes of illustration only and are not intended to limit the scope of the invention. The drawings are not necessarily to scale, and certain features may be exaggerated, simplified, or omitted for clarity. Like reference numerals refer to like elements throughout the drawings where applicable. The embodiments illustrated represent exemplary implementations of the invention and are not intended to limit the invention to the specific structures, arrangements, or configurations shown.

FIG. 1 illustrates a slide bracket alignment mechanism installed on a tripod-mounted electronic device, showing an alignment and stabilization bracket positioned around a central tripod pillar and moved from an initial position to a final position in which the bracket engages tripod support fins or beams to provide vertical bracing.

FIG. 2 illustrates a rotational alignment mechanism, showing an alignment and stabilization bracket positioned around an OEM mounting base, wherein an electronic device is rotated from an initial position to a final rotated position in which the electronic device engages bracket engagement tabs and a vertical bracing surface to limit rotation.

The drawings are provided for illustrative purposes only and are not intended to define or limit the scope of the claimed invention. Variations, modifications, and alternative configurations consistent with the disclosure are considered to be within the scope of the appended claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention relates to an alignment and stabilization accessory for tripod-mounted electronic devices, and more particularly to an accessory designed to correct rotational looseness and alignment inconsistencies between an original equipment manufacturer (OEM) mounting interface and a tripod. Although the invention is described primarily in connection with a sports launch monitor device, it should be understood that the principles disclosed herein are applicable to a wide variety of electronic measurement, imaging, sensing, or data collection devices that require precise and repeatable alignment when mounted on a tripod or similar support structure.

Many tripod-mounted electronic devices rely on a threaded or keyed interface between the device and a tripod mounting plate or central pillar. In practice, such interfaces often exhibit rotational play due to manufacturing tolerances, material deformation, wear, or design constraints intended to facilitate easy attachment and removal.

While this looseness may be acceptable for general-purpose mounting, it becomes problematic in applications requiring precise alignment between the electronic device and external reference features, such as tripod legs, alignment stands, laser guides, or calibration accessories.

In the context of sports launch monitors and similar devices, accurate alignment is particularly critical. These devices often rely on precise orientation relative to a target line, ground plane, or external reference axis. Even small angular deviations can result in inaccurate measurements, inconsistent data, or user frustration during setup. The problem is exacerbated when the device is used in conjunction with aftermarket or OEM accessories that assume a fixed orientation between the device housing and the tripod structure.

The present invention addresses these deficiencies by providing a mechanical alignment and stabilization accessory that engages both the electronic device and the tripod itself. Rather than relying solely on the OEM mounting interface to define rotational alignment, the invention introduces additional structural engagement points that constrain rotation and force the device into a repeatable, predetermined orientation relative to the tripod legs or other tripod features.

In one aspect, the invention comprises a bracket configured to engage an OEM mounting base of the electronic device. The bracket is shaped to index to one or more geometric features of the OEM base, such as flats, contours, protrusions, recesses, or peripheral edges. This indexing ensures that the bracket assumes a known rotational orientation relative to the electronic device when installed. The bracket may clip, snap, slide, or otherwise attach to the OEM base without requiring modification to the electronic device.

In addition to engaging the electronic device, the bracket is configured to engage one or more structural features of a tripod. In one embodiment, these structural features include support fins, beams, or gussets that connect the tripod legs to a central pillar or mounting hub. Such support structures are commonly present in tripods and define a fixed angular relationship with the tripod legs. By engaging these structures, the bracket effectively references the tripod's geometry rather than relying on the tolerances of the OEM mounting interface.

In a first primary embodiment, the bracket is designed to be installed around a central pillar of the tripod. The bracket may include an internal bore, aperture, or open-sided channel sized to fit around the central pillar. The bracket is initially positioned below the OEM mounting interface and then moved, such as by sliding upward along the central pillar, into engagement with the tripod's support structures. As the bracket moves into position, contact surfaces on the bracket engage corresponding surfaces on the support structures, creating vertical bracing forces.

These vertical bracing forces act to push or bias the electronic device into a fixed rotational orientation relative to the tripod. Because the support structures are rigidly connected to the tripod legs, the resulting alignment ensures that the electronic device is consistently oriented with respect to the tripod leg positions. This alignment is independent of any looseness or rotational play in the OEM mounting interface itself.

The bracket may include multiple engagement surfaces arranged circumferentially to correspond to multiple support fins or beams. In some embodiments, the engagement surfaces are planar, while in others they may be curved, angled, or contoured to match the geometry of the tripod structures. The engagement may be frictional, interference-based, or keyed, depending on design requirements and material selection.

The bracket may further include retention features that maintain its position once engaged. Such features may include snap tabs, spring elements, detents, set screws, clamps, or friction-enhancing materials. In one example, the bracket clips onto the OEM base of the electronic device, thereby maintaining vertical positioning while still allowing installation and removal without tools.

In a second embodiment, the invention provides a rotational stabilization mechanism that operates during installation of the electronic device onto the OEM mounting interface. In this embodiment, the bracket is positioned around or adjacent to the OEM mounting mechanism prior to installation of the electronic device. The bracket includes internal vertical bracing walls or stops arranged to engage the electronic device as it is rotated into its normal mounted position.

As the electronic device is rotated onto the OEM mount, one or more surfaces of the device housing come into contact with the bracing walls of the bracket. Once contact is made, further rotation is prevented, thereby defining a fixed rotational endpoint. This endpoint corresponds to a desired alignment between the electronic device and the tripod legs. The bracket thus functions as a rotational stop that compensates for over-rotation or under-rotation caused by loose OEM tolerances.

The bracing walls may be arranged symmetrically or asymmetrically depending on the shape of the electronic device and the desired alignment orientation. In some embodiments, multiple bracing walls define a pocket or cavity that closely conforms to the external geometry of the device. In other embodiments, fewer contact points are used to define the rotational endpoint while minimizing material usage.

The rotational stabilization embodiment may be used independently or in combination with the sliding bracket embodiment. For example, a system may include both a slide-up vertical bracing bracket and a rotational stop bracket to provide redundant or enhanced alignment control. Such configurations may be beneficial in environments subject to vibration, repeated setup and teardown, or frequent accessory changes.

The bracket of the present invention may be manufactured from a wide variety of materials, including plastics, composites, metals, or combinations thereof. Injection-molded thermoplastics may be used for lightweight, low-cost implementations, while machined or cast metals may be preferred for increased durability or stiffness. Elastomeric materials may be incorporated at contact surfaces to improve grip, reduce vibration, or prevent cosmetic damage to the electronic device or tripod.

The geometry of the bracket may be customized to accommodate different electronic devices, tripod models, or accessory ecosystems. In some embodiments, modular or adjustable features are provided to allow a single bracket design to work across multiple configurations. For example, interchangeable inserts, adjustable contact surfaces, or flexible segments may be used to accommodate dimensional variations.

An important advantage of the present invention is its compatibility with existing OEM devices and tripods. The bracket is designed to be installed without permanent modification to either the electronic device or the tripod. This allows users to retrofit existing equipment and maintain compatibility with manufacturer warranties and future upgrades.

Another significant advantage is improved repeatability. Because the bracket references fixed tripod geometry rather than relying on user judgment or manual alignment, the electronic device can be set up in the same orientation each time it is installed. This repeatability is particularly valuable for training environments, data comparison across sessions, and professional applications where consistency is critical.

The invention further enables reliable use of alignment-dependent accessories. Accessories such as laser alignment tools, calibration stands, leveling bases, and targeting aids often assume that the electronic device is aligned with the tripod legs or a known reference axis. By enforcing this alignment mechanically, the bracket ensures that such accessories function as intended, regardless of OEM mounting variability.

While the invention has been described with reference to specific embodiments, it should be understood that these embodiments are illustrative and not limiting. Variations in shape, size, attachment method, and engagement geometry may be made without departing from the scope of the invention. The bracket may engage different tripod features, such as leg hinges, spreaders, or mounting plates, depending on tripod design.

Additionally, while the invention is particularly well-suited for sports launch monitors, it may be applied to cameras, scanners, surveying instruments, scientific sensors, and other devices where rotational alignment relative to a tripod is important. The principles of indexing to tripod structure and constraining rotation are broadly applicable across many industries.

In operation, the user mounts the electronic device to the tripod using the OEM interface as normal. The bracket is then installed or engaged, either by sliding into position along the tripod pillar or by engaging the device during rotational installation. Once engaged, the bracket mechanically enforces alignment without requiring additional adjustment or calibration.

Removal of the bracket is equally straightforward, allowing the device to be detached from the tripod when desired. The bracket may remain attached to the device, the tripod, or be stored separately depending on user preference and design configuration.

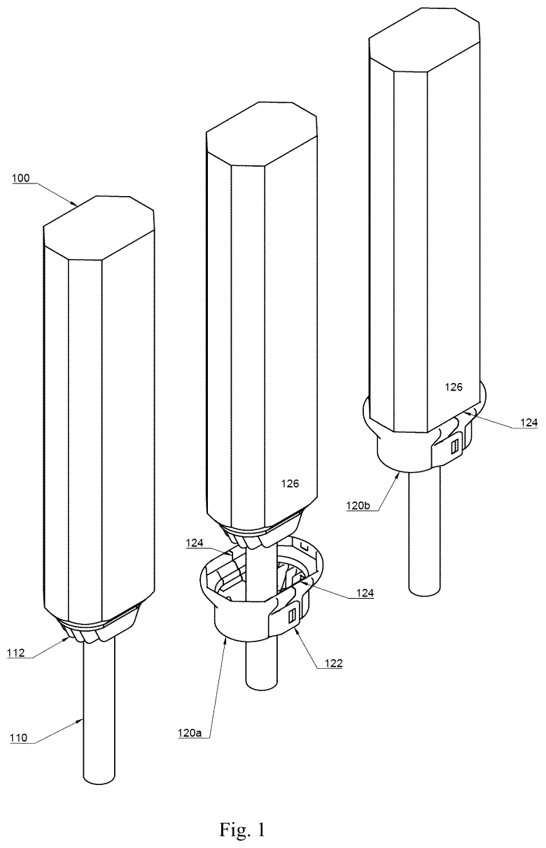

The invention can be further understood by provide drawings. FIG. 1 illustrates an electronic device 100, comprising a tripod-mounted electronic measurement device or launch monitor, supported by a tripod central pillar 110 and tripod support fins or beams 112. An alignment and stabilization bracket is shown in an initial position 120a and in a final position 120b.

In the initial position 120a, the alignment and stabilization bracket 120a is positioned around the tripod central pillar 110 prior to engagement. The bracket includes a bracket clamp or retention feature 122 configured to secure the bracket to the tripod central pillar 110.

The alignment and stabilization bracket 120b further includes engagement surfaces. These bracket engagement surfaces are arranged to interact with the tripod support fins or beams 112 when the bracket is moved from the initial position 120a to the final position 120b.

In the final position 120b, the alignment and stabilization bracket 120b is shown with a vertical bracing surface or wall 126 engaged with the bracket engagement surfaces 124. In this engaged position, the alignment and stabilization bracket 120b provides rotational bracing through the interaction between the vertical bracing surface or wall 126 and the bracket engagement surfaces 124.

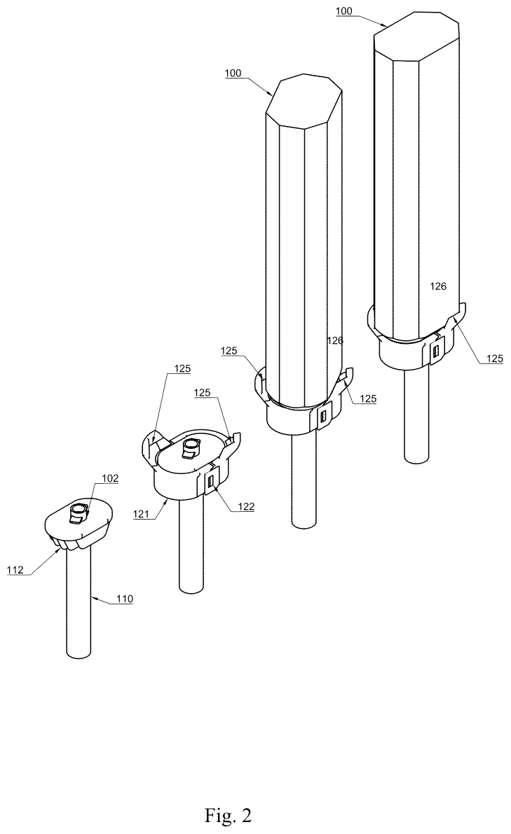

FIG. 2 illustrates an electronic device 100 shown first in an initial position to engage an OEM tripod connection and then in a final rotated position. The electronic device 100 is supported by a tripod central pillar 110 and tripod support fins or beams 112.

An OEM mounting base of the electronic device 102 is shown mounted on the tripod central pillar 110. An alignment and stabilization bracket for rotational alignment 121 is positioned relative to the OEM mounting base 102. The alignment and stabilization bracket 121 includes a bracket clamp or retention feature 122 configured to secure the bracket in position. The bracket further includes bracket engagement tabs 125.

As the electronic device 100 is rotated from its initial position into its final rotated position, the vertical bracing surface or wall 126 engages the bracket engagement tabs 125. A vertical bracing surface or wall 126 is positioned to interact with the bracket engagement tabs 125 in the final rotated position to provide rotational alignment.

Accordingly, the present invention provides a simple, robust, and effective solution to a long-standing problem associated with loose tripod mounting interfaces. By leveraging existing tripod geometry and introducing targeted mechanical constraints, the invention significantly improves alignment consistency, usability, and accessory compatibility for tripod-mounted electronic devices.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. An alignment and stabilization accessory for a tripod-mounted electronic device, comprising:
a bracket configured to engage an OEM mounting base of the electronic device;
wherein the bracket further engages one or more structural features of a tripod;
and wherein the bracket constrains rotational movement of the electronic device relative to the tripod to maintain a predetermined alignment with tripod leg orientation.

2. The accessory of claim 1, wherein the bracket indexes to support fins or beams of the tripod.

3. The accessory of claim 1, wherein the bracket reduces alignment variability caused by tolerance differences in the OEM mounting interface.

4. The accessory of claim 1, wherein the bracket is removable without modification to the OEM device or tripod.

5. The accessory of claim 1, wherein the predetermined alignment corresponds to an axis defined by the tripod legs.

6. The accessory of claim 1, wherein the electronic device is a sports launch monitor.

7. An alignment system for a tripod-mounted electronic device, comprising:
a bracket configured to be installed around a central pillar of a tripod;
wherein the bracket is movable along the pillar into engagement with tripod support structures;
and wherein engagement provides vertical bracing that forces the electronic device into rotational alignment with the tripod.

8. The system of claim 7, wherein the bracket slides upward along the central pillar to engage the tripod support structures.

9. The system of claim 7, wherein engagement creates a rigid interface between the electronic device and tripod.

10. The system of claim 7, wherein the bracket clips onto the OEM base of the electronic device.

11. The system of claim 7, wherein the vertical bracing aligns the electronic device with an alignment stand.

12. The system of claim 7, wherein the bracket is compatible with multiple tripod models.

13. A method of stabilizing rotational alignment of a tripod-mounted electronic device, comprising:
mounting the electronic device to an OEM tripod interface;
installing a bracket that engages the OEM interface and tripod structure;
rotating or positioning the electronic device into contact with bracing surfaces of the bracket;
and preventing further rotation to maintain consistent alignment.

14. The method of claim 13, wherein the electronic device is rotated into position until contacting vertical bracing walls.

15. The method of claim 13, wherein the bracket prevents misalignment during accessory installation.

16. The method of claim 13, wherein the alignment is repeatable across multiple setup cycles.

17. The method of claim 13, wherein the bracket accommodates future aftermarket accessories.

18. The method of claim 13, wherein the bracket compensates for OEM mounting looseness.
